(19) United States
(12) Patent Application Publication
(10) Pub. No.: US 2007/0146485 A1
(43) Pub. Date: Jun. 28, 2007

(54) Video display apparatus and video display method

(75) Inventor: Kenichi Horikoshi, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/641,695

(22) Filed: Dec. 20, 2006

(30) Foreign Application Priority Data
Dec. 23, 2005 (JP) 2005-371128

(51) Int. Cl. H04N 3/20; H04N 5/00

(52) U.S. Cl. 348/173; 348/607

(57) ABSTRACT

According to one embodiment, a video display apparatus includes a detection unit which detects a video density change based on a given video signal, a processing unit which processes the video signal to change a position of a video based on the video signal on a screen at timing of the video density change when the video density change detected by the detection unit is not lower than a predetermined amount, and a display unit which displays the video on the screen according to the video signal processed by the processing unit.

### CROSS-REFERENCE TO RELATED APPLICATIONS

This application is based upon and claims the benefit of priority from Japanese Patent Application No. 2005-371128, filed Dec. 23, 2005, the entire contents of which are incorporated herein by reference.

### BACKGROUND

1. Field

One embodiment of the invention relates to a video display apparatus for displaying a video, and particularly to the video display apparatus and video display method for changing a display position of the video to prevent burn-in.

2. Description of the Related Art

Recently with development and wide spread of digital video instruments, there is increased a technical demand for a flat panel display and the like which are a display device. In such flat panel displays, when a range having a large brightness difference of a display video is held for long hours, there is a phenomenon that a color filter on a panel surface is degraded to decrease brightness in the degraded range. In order to avoid the brightness decrease, there is well known a method of reducing burn-in on the panel surface by moving a video display position at constant time periods.

Patent document 1 (Jpn. Pat. Appln. KOKAI Publication No. 2005-49784) discloses a technique in which a summation of motion vectors is determined from a moving image component of a video signal to move the video in a direction according to the summation of the motion vectors, thereby preventing the burn-in of the screen.

However, in the conventional technique disclosed in the patent document 1, because it is difficult that the motion vector of the moving image is completely aligned with the image motion direction, there is a problem that it is not always guaranteed that the image is moved without imparting uncomfortable feeling to an audience.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of a video display apparatus according to an embodiment of the invention;

FIG. 2 is a block diagram showing a detailed configuration of the video display apparatus according to the embodiment of the invention;

FIG. 3 is a block diagram showing a function of the video display apparatus according to the embodiment of the invention;

FIG. 4 is a block diagram showing another function of the video display apparatus according to the embodiment of the invention;

FIG. 5 is an explanatory view showing an example of density difference detection of the video display apparatus according to the embodiment of the invention;

FIG. 6 is an explanatory view showing an example of the density difference detection of the video display apparatus according to the embodiment of the invention;

FIG. 7 is an explanatory view showing transition of a display position of the video display apparatus according to the embodiment of the invention;

FIG. 8 is a flowchart showing an example of a processing operation of the video display apparatus according to the embodiment of the invention;

FIG. 9 is a flowchart showing another example of the processing operation of the video display apparatus according to the embodiment of the invention;

FIG. 10 is a flowchart showing another example of the processing operation of the video display apparatus according to the embodiment of the invention; and

FIG. 11 is a flowchart showing another example of the processing operation of the video display apparatus according to the embodiment of the invention.

### DETAILED DESCRIPTION

Various embodiments according to the invention will be described hereinafter with reference to the accompanying drawings. In general, according to one embodiment of the invention, there is provided a video display apparatus comprising: a detection unit which detects a video density change based on a given video signal; a processing unit which processes the video signal to change a position of a video based on the video signal on a screen at timing of the video density change when the video density change detected by the detection unit is not lower than a predetermined amount; and a display unit which displays the video on the screen according to the video signal processed by the processing unit.

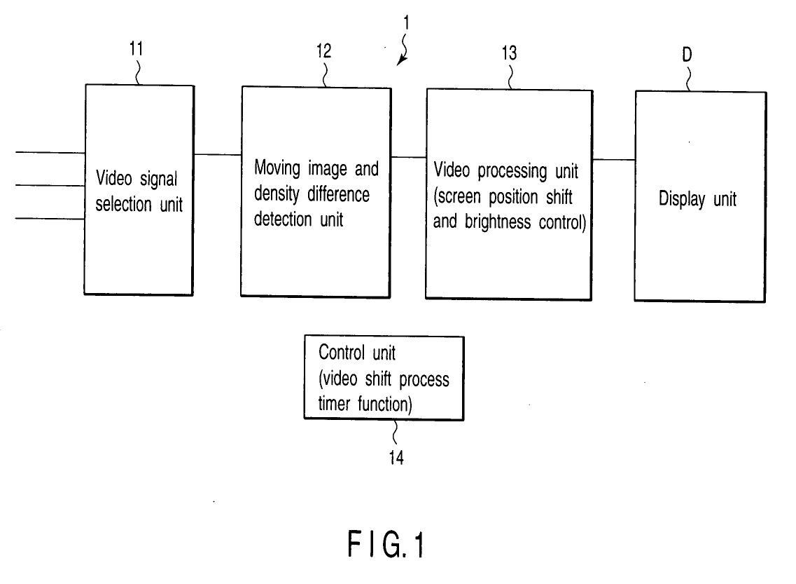

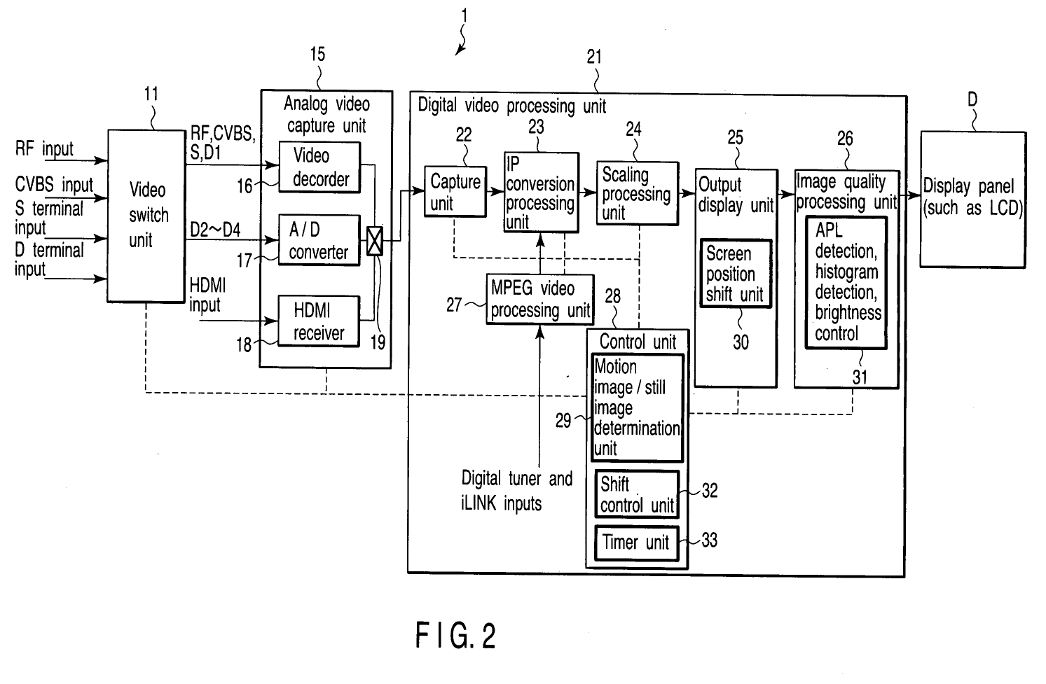

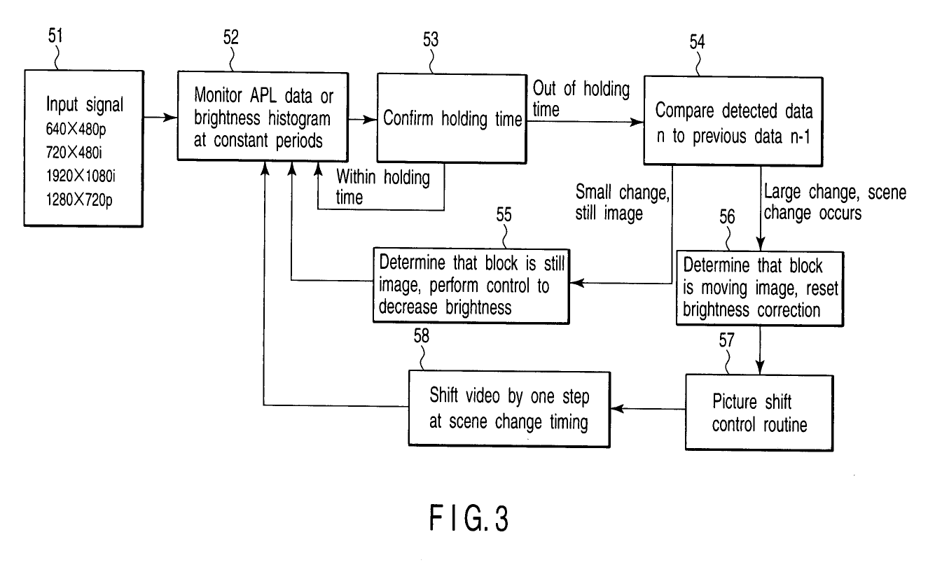

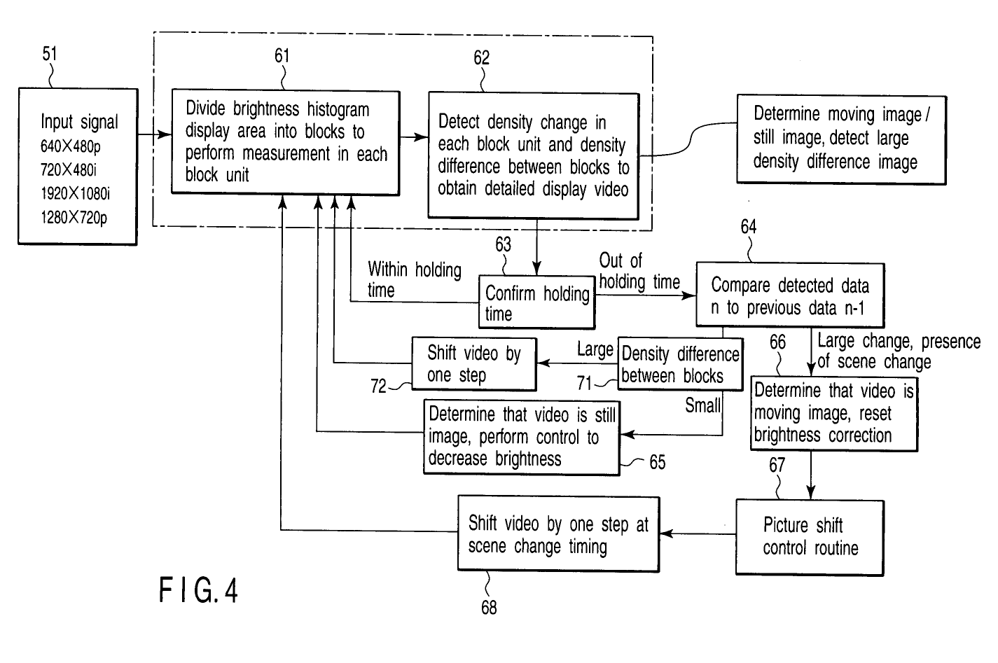

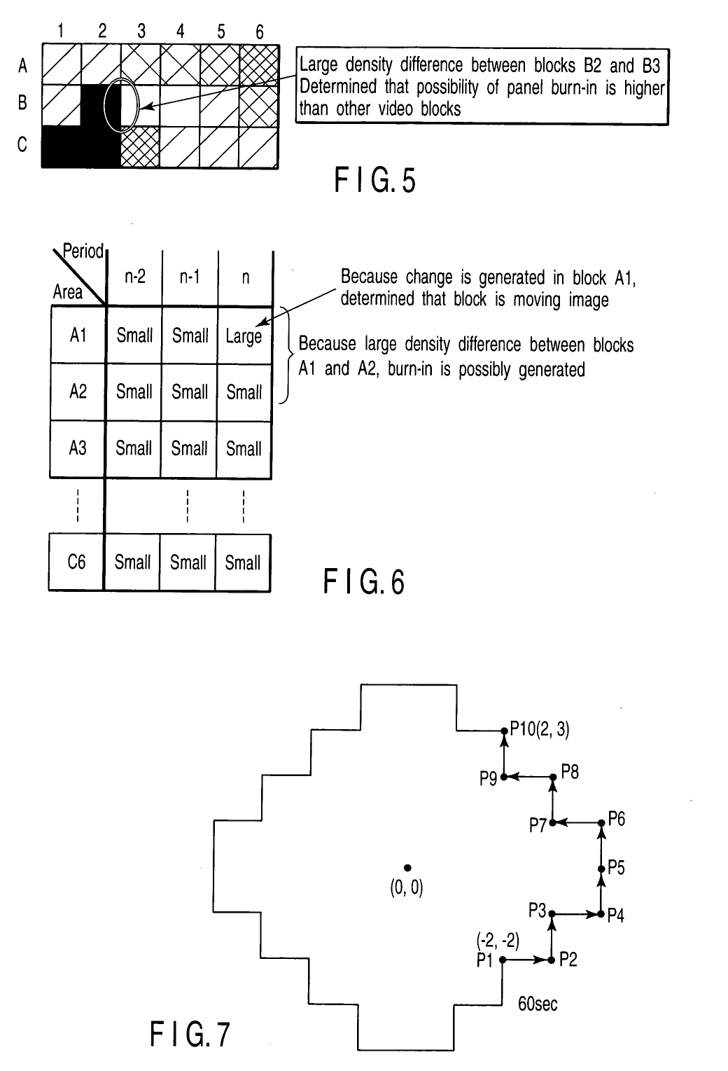

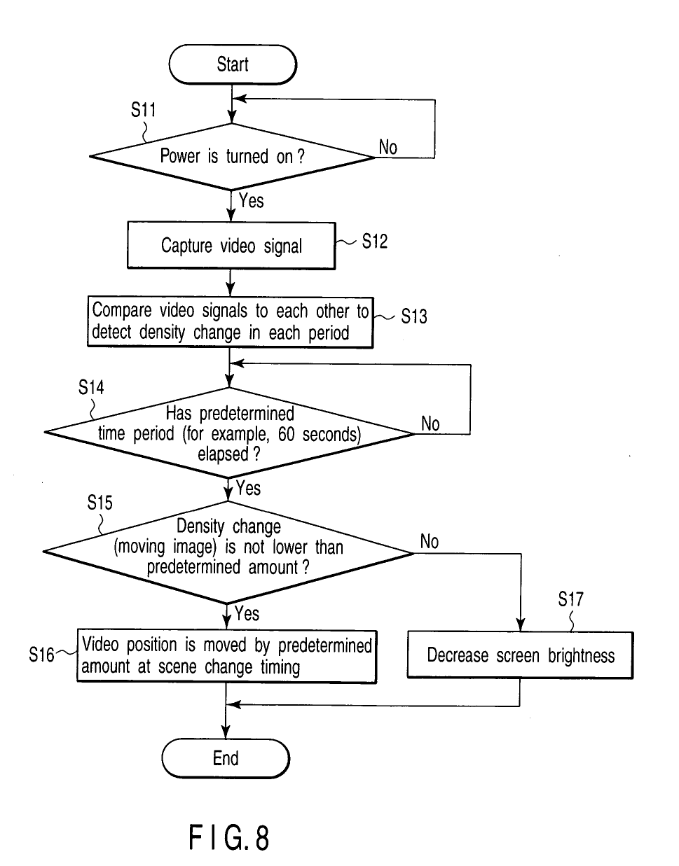

The moving image is detected to move the video at scene change timing, which allows the screen burn-in to be prevented without imparting uncomfortable feeling to an audience. An embodiment of the invention will be described in detail with reference to the drawings. FIG. 1 is a block diagram showing a configuration of a video display apparatus according to an embodiment of the invention, FIG. 2 is a block diagram showing a detailed configuration of the video display apparatus, FIGS. 3 and 4 are block diagrams showing a function of the video display apparatus, FIG. 5 is an explanatory view showing an example of density difference detection of the video display apparatus, FIG. 6 is an explanatory view showing an example of the density difference detection of the video display apparatus, FIG. 7 is an explanatory view showing transition of a display position of the video display apparatus, and FIGS. 8 to 11 are flowcharts showing an example of a processing operation of the video display apparatus.

<Video Display Apparatus According to one Embodiment of the Invention>

(Configuration and Function)

Referring to FIG. 1, a video display apparatus 1 according to an embodiment of the invention includes a video signal selection unit 11, a moving image and density difference detection unit 12, a video processing unit 13, a display unit D such as a flat panel display, and a control unit 14. The video signal selection unit 11 receives plural video signals to supply the desired video signal to a subsequent stage. The moving image and density difference detection unit 12 receives the video signal, and makes a determination of the moving image or still image to detect the density difference between blocks based on a density value of the video signal. The video processing unit 13 shifts a screen display position of the video formed by the video signal, and controls the brightness of the video. The control unit 14 controls the whole operations, and incorporates a timer function to control the later-mentioned video shift process. In the video display apparatus 1, the basic structure including only the components necessary to realize the action and effect of the invention is shown in FIG. 1 by way of example.

In the video display apparatus 1 having the above-described configuration, under the control of the control unit 14, the video signal selected by the video signal selection unit 11 is supplied to the moving image and density difference detection unit 12, and the moving image and density difference detection unit 12 determines whether the video shown by the video signal is the moving image or the still image. The moving image and density difference detection unit 12 also obtains the density difference between the blocks (brightness difference on display) by detecting the video density in each of the plural blocks shown in FIG. 5. The video processing unit 13 performs a scaling process and the like to display the video on the display D of the subsequent stage, and the video processing unit 13 shifts the position of the video of the video signal on the display D to control the brightness of the displayed video.

When the moving image of the video signal is detected by a video shift process function of the control unit 14, the burn-in can be prevented without imparting the uncomfortable feeling to the audience by performing the screen position shift process at the scene change timing. The detailed video shift process will be described later.

(Detailed Configuration and Function)

FIG. 2 shows the detailed video display apparatus 1. Referring to FIG. 2, the video display apparatus 1 includes a video switch unit 11, an analog video capture unit 15, a digital video processing unit 21, and the display panel D such as LCD (Liquid Crystal Display). An RF signal, a CVBS signal, an S terminal signal, and a D terminal signal are inputted to the video switch unit 11. Each signal is supplied to the analog video capture unit 15 from the video switch unit 11, and the analog video capture unit 15 includes a video decoder 16, an A/D converter 17, an HDMI receiver 18, and a switch unit 19 which selectively outputs the signals. The digital video processing unit 21 performs a digital video process to the signal outputted from the analog video capture unit 15. The display D displays the video signal to which the video process is performed.

The digital video processing unit 21 includes a capture unit 22, an IP conversion processing unit 23, a scaling processing unit 24, an output display unit 25, and an image quality processing unit 26. The video signal is temporarily stored in the capture unit 22. The IP conversion processing unit 23 converts an interlace signal into a progressive signal. The scaling processing unit 24 performs a scaling process to the video signal according to a standard. The output display unit 25 includes a screen position shift unit 30, and sets a clock for operation timing of the display panel to perform a synchronous process. The image quality processing unit 26 includes a function 31 to determine the final image quality of the video signal. Examples of the function 31 include an APL detection function of detecting average brightness of the screen, a histogram detection of the video signal, and brightness control. The digital video processing unit 21 further includes an MPEG video processing unit 27 and a control unit 28. The MPEG video processing unit 27 receives the input such as a digital tuner and iLINK® to decode an MPEG video. The control unit 28 is connected to each of main parts to perform the whole control, and the control unit 28 includes a motion image/still image determination unit 29, a shift control unit 32, and a timer unit 33. The motion image/still image determination unit 29 determines whether the video signal is the motion or the still image. The shift control unit 32 performs shift control of a display coordinate of the video, which is one of the features of the invention. The timer unit 33 performs timing of a predetermined time period such as 30 seconds and 60 seconds.

In the video display apparatus 1 having the above configuration, the video is displayed on the display D as follows. That is, the video switch unit 11 selects one signal from the RF signal, the CVBS signal, the S terminal signal, and the D terminal signal to supply the selected signal to the analog video capture unit 15. The analog video capture unit 15 decodes the supplied video signals with the video decoder 16, the A/D converter 17, and the HDMI receiver 18, respectively, and the analog video capture unit 15 supplies the decoded video signal to the digital video processing unit 21 through the switch unit 19.

In the digital video processing unit 21, under the control of the control unit 28, the supplied video signal having, e.g., ITU-R.BT60 format is temporarily stored in the capture unit 22. When the input such as the digital tuner, ground wave digital, and iLINK is inputted, the MPEG video processing unit 27 decodes the MPEG video and supplies the decoded video to the IP conversion processing unit 23.

The IP conversion unit 23 appropriately performs the IP conversion of the interlace signal into the progressive signal to the video signal supplied from the capture unit 22 or to the video signal supplied from the MPEG video processing unit 27, and the IP conversion unit 23 outputs the signal to the subsequent stage. When the input such as the digital tuner, and iLINK is supplied, the IP conversion unit 23 performs the decode process as the MPEG video, and supplies the video to the IP conversion processing unit 23.

The scaling processing unit 24 receives the video signal supplied from the IP conversion unit 23. Then, under the control of the control unit 28, the scaling processing unit 24 performs the scaling process according to the standard of the display panel D of the subsequent stage, an aspect ratio of the video signal, and the like. The video signal is supplied to the output display unit 25, and the output display unit 25 sets the clock for the operation timing of the display panel to perform the synchronous process with the video signal. The screen position shift unit 30 also performs the process of shifting the screen display position of the video.

Under the control of the control unit 28, the processing unit 31 of the image quality processing unit 26 performs the control of the average brightness of the screen, brightness control, color adjustment, and the like to the video signal outputted from the output display unit 25, and the processing unit 31 outputs the video signal to the display panel D.

The processing unit 31 of the image quality processing unit 26 performs the APL detection and the histogram detection, and the processing unit 31 supplies the result to the control unit 28. The control unit 28 uses the result for the later-mentioned shift control.

In the display panel D, the video is displayed on the screen based on the video signal supplied from the image quality processing unit 26, and sometimes the burn-in is generated due to the display of the still image for a long time. Therefore, the video shift process is required for the countermeasure against the burn-in.

(Video Shift Process)

Then, the video shift process according to an embodiment of the invention which is a process of preventing the burn-in of the display will be described in detail with reference to block diagrams of FIGS. 3 and 4 and flowcharts of FIGS. 8 to 11.

The video shift process of the embodiment is one in which, in FIG. 1, the video signal is not directly outputted to the display D, but the video display coordinate on the screen of the display D is shifted (moved) for a predetermined time period (for example, 60 seconds) based on whether the video shown by the video signal is the moving image or the still image (see FIG. 6) or based on the presence or absence of the large density difference between the blocks of the video (see FIGS. 5 and 6). That is, as shown in FIG. 7, the video display coordinate displayed on the screen of the display D is placed not on the center P0(O,0) but on P1(−2,−2), and the video display coordinate is sequentially moved from P1 to P2, . . . , P10 in every about 60 seconds. At this point, the video display coordinate is moved not at the moving timing of the predetermined time of 60 seconds but at the scene change timing which is detected when the change amount of the moving image becomes the maximum, which minimizes the uncomfortable feeling of the audience.

(Description with Block Diagram)

The video shift process of the embodiment will be described with reference to the block diagram of FIGS. 3 and 4 which show the video shift process. FIG. 1 schematically shows the video display apparatus 1 of the invention, and FIG. 2 shows the detail of the embodiment. The relationship between FIGS. 1 and 2 will be described below.

The video signal selection unit 11 in the video display apparatus 1 of FIG. 1 corresponds to the video switch 11 in the video display apparatus 1 of FIG. 2, and the moving image and density difference detection unit 12 in the video display apparatus 1 of FIG. 1 corresponds to the motion image/still image determination unit 29 of the control unit 28 and the APL detection function and histogram detection function of the processing unit 31 of the image quality processing unit 26 in the video display apparatus 1 of FIG. 2. The screen position shift process and brightness control of the video processing unit 13 in the video display apparatus 1 of FIG. 1 corresponds to the screen position shift unit 30 of the output display unit 25 and the brightness control function of the processing unit 31 of the image quality processing unit 26 in the video display apparatus 1 of FIG. 2, and the control function and timer function of the video shift process performed by the control unit 14 in the video display apparatus 1 of FIG. 1 corresponds to the shift control unit 32 and the timer unit 33 in the video display apparatus 1 of FIG. 2.

In the following description, the video shift process is performed by the moving image and density difference detection unit 12, the video processing unit 13, the control function and timer function of the video shift process of the control unit 14 in the video display apparatus 1 of FIG. 1. Therefore, it can be understood that the video shift process is performed by the corresponding components in the video display apparatus 1 of FIG. 2.

First Block Diagram (FIG. 3)

In an example of the video shift process shown in the block diagram of FIG. 3, under the control of the control unit 14, the moving image and density difference detection unit 12 forms APL data or the brightness histogram by monitoring the input signal (any one of 640×480p, 720×480i, 1920×1080i, and 1280×720p) selected (block 51) by the video signal selection unit 11 of FIG. 1 at predetermined time periods. When the predetermined time period (for example, 60 seconds) which is a holding time is timed (blocks 52 and 53), the video shift process goes to a process of block 54.

The moving image detection unit 12 compares detected data n to previous data n−1 (block 54). When a difference between the density value of the video signal having a period n−1 in an area A1 and the density value of the video signal having a period n in the area A1 is not lower than a predetermined amount (first threshold) in a table of FIG. 6, due to the large change, it is determined that the A1 block is the moving image. When the difference between the density value of the video signal having the period n−1 in the area A1 and the density value of the video signal having the period n in the area A1 is not lower than a predetermined amount (second threshold: second threshold>first threshold), it is determined that the A1 block is the moving image and the scene change occurs.

For the first threshold for determining the still image or the moving image and the second threshold for determining the existence of the scene change, it is preferable to select the optimum value from many samples. The thresholds are precisely set from the many samples to detect the detailed video state, which allows the video shift process to be effectively performed. According to circumstances, the video shift process is preferably performed by substituting the first threshold for determining the still image or the moving image and the second threshold for determining the existence of the scene change by the same value.

When the density difference is lower than the predetermined amount (first threshold), the moving image detection unit 12 determines that the A1 block is the still image, and the control unit 14 controls the brightness control function of the video processing unit 13 to decrease the screen brightness by a predetermined amount such that the display D is protected (block 55). Then, the video shift process goes to the monitoring of the block 52. When the density difference is not lower than the predetermined amount (first threshold), the moving image detection unit 12 determines that the A1 block is the moving image, and the control unit 14 resets the brightness control function of the video processing unit 13 (block 56). Then, the video shift process goes to a video shift control routine, and the moving image detection unit 12 detects the timing of the scene change (block 57). For example, as shown in FIG. 7, the video is shifted by one step at the scene change timing from the positional coordinate P3 to the positional coordinate P4 (block 58), and the video shift process goes to the monitoring of the block 52 again. Thus, the video is shifted at the scene change timing, which allows the video shift process to be realized without imparting the uncomfortable feeling to the audience.

Second Block Diagram (FIG. 4)

Another example of the video shift process of the embodiment will be described with reference to the block diagram of FIG. 4. Referring to FIG. 4, under the control of the control unit 14, the moving image and density difference detection unit 12 forms APL data or the brightness histogram in block unit shown in FIG. 5 by monitoring the input signal (any one of 640×480p, 720×480i, 1920×1080i, and 1280×720p) selected (block 51) by the video signal selection unit 11 of FIG. 1 at predetermined time periods (block 61). As used herein the block shall mean A1, A2, . . . , A6, B1, . . . , C5, C6 and the like. The moving image and density difference detection unit 12 detects the density difference and density change in each block unit to obtain the detailed image information (block 62).

When the predetermined time period (for example, 60 seconds) which is the holding time is timed (block 63), the video shift process goes to the process of block 64. The moving image detection unit 12 compares the detected data n to the previous data n−1 (block 64). When the difference between the density value of the video signal having the period n−1 in the area A1 and the density value of the video signal having the period n in the area A1 is not lower than the predetermined amount (first threshold) in the table of FIG. 6, due to the large change, it is determined that the A1 block is the moving image. When the difference between the density value of the video signal having the period n−1 in the area A1 and the density value of the video signal having the period n in the area A1 is not lower than the predetermined amount (second threshold: second threshold>first threshold), it is determined that the A1 block is the moving image and the scene change occurs.

For the first threshold for determining the still image or the moving image and the second threshold for determining the existence of the scene change, it is preferable to select the optimum value from many samples. The thresholds are precisely set from the many samples to detect the detailed video state, which allows the video shift process to be effectively performed.

When the density difference is lower than the predetermined amount (first threshold), the moving image detection unit 12 determines that the A1 block is the still image, and the moving image detection unit 12 determines whether or not the density difference between the blocks is not lower than a predetermined amount. When the density difference between the blocks is lower than the predetermined amount (block 71), the control unit 14 controls the brightness control function of the video processing unit 13 to decrease the screen brightness by a predetermined amount such that the display D is protected (block 65). Then, the video shift process goes to the monitoring of the block 61. When the density difference is not lower than the predetermined amount (first threshold), the moving image detection unit 12 determines that the A1 block is the moving image, and the control unit 14 resets the brightness control function of the video processing unit 13 (block 66). Then, the video shift process goes to the video shift control routine, and the moving image detection unit 12 detects the timing of the scene change (block 67). For example, as shown in FIG. 7, the video is shifted by one step at the scene change timing from the positional coordinate P3 to the positional coordinate P4 (block 68), and the video shift process goes to the monitoring of the block 61 again.

As shown in FIG. 6, in the block 71, when it is determined that the density difference between the blocks (A1 and A2) is not lower than the predetermined value, for example, the video is shifted by one step from the positional coordinate P3 to the positional coordinate P4 (block 72), and the video shift process goes to the monitoring of the block 61 again. Therefore, the large brightness difference which causes the burn-in on the display D can be prevented from occurring.

Thus, in the second block diagram shown in FIG. 4, as with the first block diagram of FIG. 3, the video is shifted at the scene change timing, which allows the video shift process to be realized without imparting the uncomfortable feeling to the audience.

(Description of Video Shift Process with Flowchart)

Another example of the video shift process of the embodiment will be described with reference to flowcharts shown in FIGS. 8 to 11. That is, the video shift process can be performed not only by the circuit system configuration as shown in FIGS. 3 and 4, but also the video shift process is generally performed by the control units 14 and 28 which are a microcomputer system having CPU and a program executed by CPU. In the latter case, preferably the video shift process is described with reference to the flowchart.

(Video Shift Process Based on Moving Image and Still Image)

In the flowchart of FIG. 8, when the power is turned on in the video display apparatus 1 of FIG. 1 (Step S11), the capture unit 22 captures the input signal (640×480p, 720×480i, 1920×1080i, 1280×720p, or the like) selected by the video signal selection unit 11 (Step S12). Under the control of the control unit 14, the moving image and density difference detection unit 12 forms the APL data or the brightness histogram in block unit as shown in FIG. 5 by monitoring the APL data or the brightness histogram at constant time periods. As used herein the block shall mean A1, A2, . . . A6, B1, . . . , C5, C6 and the like. As shown in FIG. 6, the moving image and density difference detection unit 12 detects the density change in each period (Step S13). Then, under the control of the control unit 14, the moving image and density difference detection unit 12 detects the density difference in each block unit (Step S14).

When the predetermined time period (for example, 60 seconds) which is the holding time is timed by the timer function of the control unit 14 (Step S14), the control unit 14 controls the moving image detection unit 12 to compare the detected data n to the previous data n−1 to determine whether the video shown by the video signal is the still image or the moving image (Step S15). When the difference between the density value of the video signal having the period n−1 in the area A1 and the density value of the video signal having the period n in the area A1 is not lower than the predetermined amount (first threshold) in the table of FIG. 6, due to the large change, it is determined that the A1 block is the moving image. When the difference between the density value of the video signal having the period n−1 in the area A1 and the density value of the video signal having the period n in the area A1 is not lower than the predetermined amount (second threshold: second threshold>first threshold), it is determined that the A1 block is the moving image and the scene change occurs (Step S15).

When the density difference is not lower than the predetermined amount (first threshold), the moving image detection unit 12 determines that the A1 block is the moving image, and the control unit 14 controls to reset the brightness control function of the video processing unit 13. Then, the flow goes to the video shift control routine. In the video shift control routine, the moving image detection unit 12 detects the scene change timing, and the video position is moved by a predetermined amount by shifting the video by one step from the positional coordinate P3 to the positional coordinate P4 at the detected scene change timing as shown in FIG. 7 (Step S16).

In Step S15, When the density difference is lower than the predetermined amount (first threshold), the moving image detection unit 12 determines that the A1 block is the still image, and the control unit 14 controls the brightness control function of the video processing unit 13 to decrease the screen brightness by a predetermined amount such that the display D is protected (Step S17).

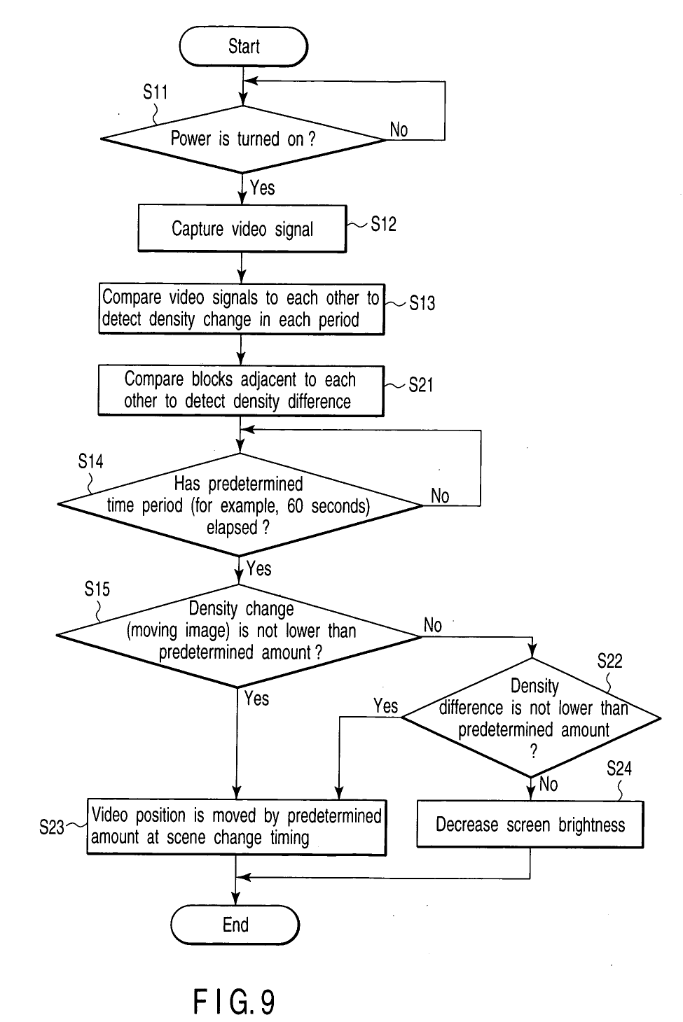

In the video shift process shown in the flowchart of FIG. 9, the video is shifted at the scene change timing, which allows the video shift process to be realized without imparting the uncomfortable feeling to the audience.

(Video Shift Process Based on Moving Image/Still Image Detection and Density Difference Between Blocks)

The video shift process shown based on moving image/still image detection and density difference between blocks will be described with reference to the flowchart of FIG. 9. In the flowchart of FIG. 9, when the power is turned on in the video display apparatus 1 of FIG. 1 (Step S11), the capture unit 22 captures the input signal (640×480p, 720×480i, 1920×1080i, 1280×720p, or the like) selected by the video signal selection unit 11 (Step S12). Under the control of the control unit 14, the moving image and density difference detection unit 12 forms the APL data or the brightness histogram in block unit as shown in FIG. 5 by monitoring the APL data or the brightness histogram at constant time periods. As used herein the block shall mean A1, A2, . . . , A6, B1, . . . , C5, C6 and the like. As shown in FIG. 6, the moving image and density difference detection unit 12 detects the density change in each period (Step S13). Then, under the control of the control unit 14, the moving image and density difference detection unit 12 detects the density difference in each block unit (Step S14).

When the predetermined time period (for example, 60 seconds) which is the holding time is timed by the timer function of the control unit 14 (Step S14), the control unit 14 controls the moving image detection unit 12 to compare the detected data n to the previous data n−1 to determine whether the video shown by the video signal is the still image or the moving image (Step S15). When the difference between the density value of the video signal having the period n−1 in the area A1 and the density value of the video signal having the period n in the area A1 is not lower than the predetermined amount (first threshold) in the table of FIG. 6, due to the large change, it is determined that the A1 block is the moving image. When the difference between the density value of the video signal having the period n−1 in the area A1 and the density value of the video signal having the period n in the area A1 is not lower than the predetermined amount (second threshold: second threshold>first threshold), it is determined that the A1 block is the moving image and the scene change occurs (Step S15).

When the density difference is not lower than the predetermined amount (first threshold), the moving image detection unit 12 determines that the A1 block is the moving image, and the control unit 14 controls to reset the brightness control function of the video processing unit 13. Then, the flow goes to the video shift control routine. In the video shift control routine, the moving image detection unit 12 detects the scene change timing, and the video position is moved by the predetermined amount by shifting the video by one step from the positional coordinate P3 to the positional coordinate P4 at the detected scene change timing as shown in FIG. 7 (Step S23).

In Step S15, when the density difference is lower than the predetermined amount (first threshold), the moving image detection unit 12 determines that the A1 block is the still image, and the moving image detection unit 12 determines whether or not the density difference between the blocks is not lower than a predetermined amount (Step S22). When the moving image detection unit 12 determines that the density difference between the blocks is lower than the predetermined amount, the control unit 14 controls the brightness control function of the video processing unit 13 to decrease the screen brightness by the predetermined amount such that the display D is protected (Step S24).

As shown in FIG. 6, in Step S22, when it is determined that the density difference between the blocks (A1 and A2) is not lower than the predetermined value, for example, the video position is moved by the predetermined amount by shifting the video by one step from the positional coordinate P3 to the positional coordinate P4 (Step S23). At this point, in the case where the video is the still image, it is not necessary to shift the video at the scene change timing. Therefore, the large brightness difference which causes the burn-in on the display D can be prevented from occurring.

Thus, in the video shift process shown in the flowchart of FIG. 9, the video is also shifted at the scene change timing, which allows the video shift process to be realized without imparting the uncomfortable feeling to the audience. For the density difference between the blocks which causes the brightness difference on the screen, the burn-in can also be prevented by performing the video shift process

(Video Shift Process in which Parameter is Changed by Density Change Amount)

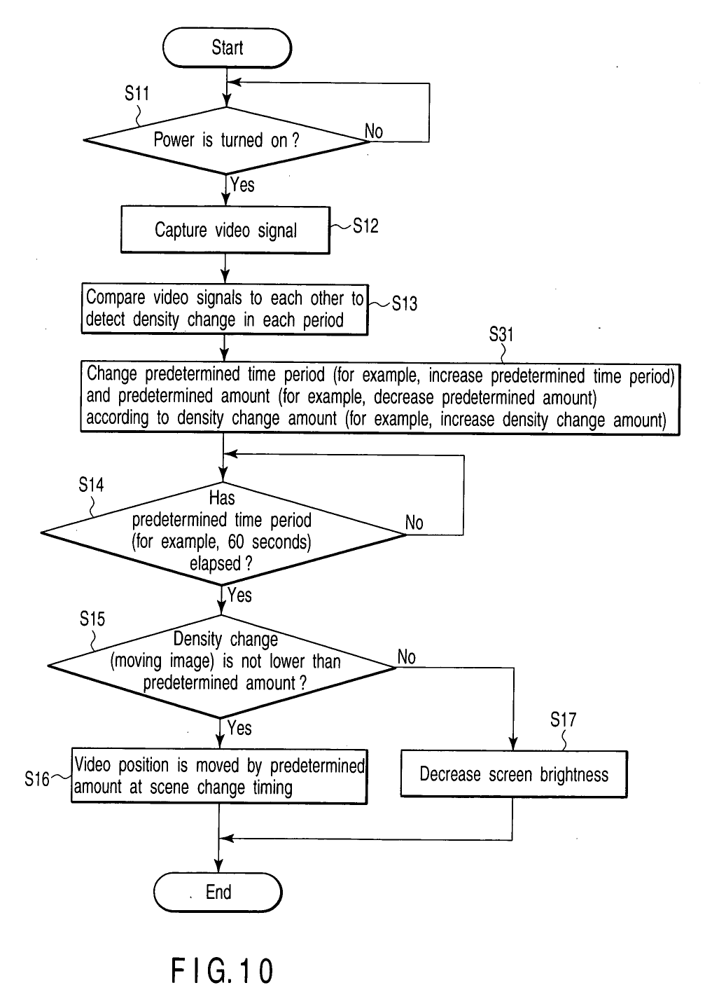

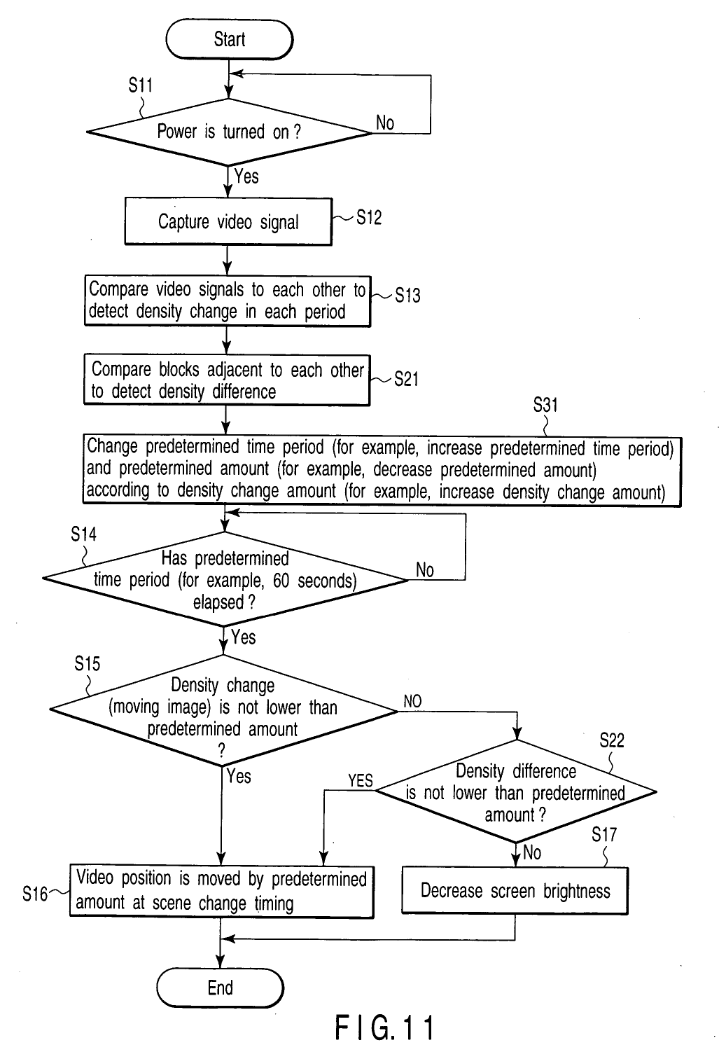

The video shift process in which a parameter is changed by the density change amount will be described with reference to the flowcharts of FIGS. 10 and 11. The flowcharts of FIGS. 10 and 11 except for the process of Step S31 are similar to the flowcharts of FIGS. 8 and 9, and the description thereof will be omitted.

In Step S31 of the flowcharts of FIGS. 10 and 11, preferably the predetermined time period of Step S14 is changed according to magnitude of the video signal density, determined by the moving image and density difference detection unit 12, through the video shift process of the control unit 14. When the change amount (an average value of the change amount is also preferable) of the video signal density detected by the moving image and density difference detection unit 12 is more than a predetermined amount (for example, third threshold), it can be determined that the prevention of the burn-in does not really matter because the motion is extremely large in the video, so that the predetermined time period (for example, 60 seconds) which is the monitoring time can further be lengthened (for example, 120 seconds). Instead of the simple comparison to the third threshold, preferably a constant is used to lengthen the predetermined time period which is the monitoring time in parallel with the change amount.

Similarly, when the change amount is more than the predetermined amount (for example, third threshold), or when the change amount tends to be increased, the video moving amount shown in FIG. 7 can be decreased. That is, because the video motion is extremely large, it is possible that the moving amount of the video coordinate is decreased from “1” to “0.5” or the like. Instead of the simple comparison to the third threshold, preferably a constant is used to decrease the moving amount period in parallel with the change amount.

On the contrary, when the change amount (or the average value of the change amount) is lower than the predetermined amount (for example, third threshold), or when the change amount tends to be decreased, it can be determined that a risk of the burn-in of the screen is enhanced, so that preferably the predetermined time period (for example, 60 seconds) which is the monitoring time is further shortened (for example, 30 seconds). Instead of the simple comparison to the third threshold, preferably a constant is used to shorten the predetermined time period which is the monitoring time in parallel with the change amount, which automatically enhances a monitoring frequency to automatically avoid the risk of the burn-in.

Similarly, when the change amount (or the average value of the change amount) is lower than the predetermined amount (for example, third threshold), or when the change amount tends to be decreased, preferably the video moving amount shown in FIG. 7 is increased to largely shift the video. That is, because the video motion is extremely small, preferably the moving amount of the video coordinate is decreased from “1” to “2”, “3”, or the like. Instead of the simple comparison to the third threshold, preferably a constant is used to increase the moving amount in parallel with the change amount, which largely moves the whole video to automatically and securely avoid the risk of the burn-in.

Preferably various modifications (such as video shift process with the block density difference and the automatic changes of the time and shift amount) of the basic specifications described above can arbitrarily be selected by user's initial setting of the operation unit (not shown) of the video display apparatus.

As described above, according to the video display apparatus of the embodiment of the invention, the video shift process is performed at the scene change of the video. Therefore, the video shift operation is inconspicuous even in the 480i signal having the rough pixel, and the uncomfortable feeling is not imparted to the audience. Furthermore, the invention also focuses attention on the density difference (brightness difference) in each block of the screen. Even if the large density difference (brightness difference) is generated, the burn-in can securely be prevented by shifting the video.

Although those skilled in the art can realize the invention by the various embodiments described above, it will be obvious to those skilled in the art that various changes and modifications may be made and applied to various modes with no inventive ability. Accordingly, it is to be understood that the invention covers a wide range which is consistent to the disclosed principles and novel features and the invention is not limited to the above embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display apparatus comprising:
a detection unit which detects a video density change based on a given video signal;
a processing unit which processes the video signal to change a position of a video based on the video signal on a screen at timing of the video density change when the video density change detected by the detection unit is not lower than a predetermined amount; and
a display unit which displays the video on the screen according to the video signal processed by the processing unit.

2. The video display apparatus according to claim 1, further comprising:
a timer unit which performs timing of a predetermined time period; and
a control unit which controls the processing unit to perform a process operation every time the timer unit performs the timing of the predetermined time period.

3. The video display apparatus according to claim 1, wherein the processing unit processes the video signal to decrease brightness of the video displayed on the display unit, when the detection unit determines that the video density change is not more than the predetermined amount.

4. The video display apparatus according to claim 1, further comprising a density difference detection unit which detects density in each of a plurality of blocks, the video based on the given video signal being divided into said plurality of blocks, thereby detecting a density difference between the blocks adjacent to each other,
wherein the processing unit changes the position based on the video signal on the screen even if the video density change of the detection unit is not more than the predetermined amount, when the density difference detection unit detects that the density difference between the blocks is not lower than the predetermined amount.

5. The video display apparatus according to claim 1, further comprising:
a timer unit which performs timing of a predetermined time period; and
a control unit which controls the processing unit to perform a process operation every time the timer unit performs the timing of the predetermined time period, the control unit performing the control to lengthen the predetermined time period when the detection unit detects an increase in video density change.

6. The video display apparatus according to claim 1, further comprising a control unit which performs the control to decrease an amount of video position movement performed by the processing unit when the detection unit detects the increase in video density change.

7. A video display method comprising:
detecting a video density change based on a given video signal;
processing the video signal to change a position of a video based on the video signal on a screen at timing of the video density change when the video density change is not lower than a predetermined amount; and
displaying the video on the screen according to the processed video signal.

8. The video display method according to claim 7, wherein the process operation is performed at predetermined time periods.

9. The video display method according to claim 7, wherein the video signal is processed to decrease brightness of the displayed video when the video density change is not more than the predetermined amount.

10. The video display method according to claim 7, wherein density is detected in each of a plurality of blocks, the video based on the given video signal being divided into said plurality of blocks, thereby a density difference between the blocks adjacent to each other is detected, and
the position based on the video signal on the screen is changed even if the video density change is not more than the predetermined amount, when the density difference between the blocks is not lower than the predetermined amount.
